(19) United States
(12) Patent Application Publication
(10) Pub. No.: US 2024/0315175 A1
(43) Pub. Date: Sep. 26, 2024

(54) Blade Arrangement for a Garden Tool

(71) Applicant: Robert Bosch GmbH, Stuttgart (DE)

(72) Inventor: Krisztian Gazsi, Miskolc (HU)

(21) Appl. No.: 18/600,733

(22) Filed: Mar. 10, 2024

(30) Foreign Application Priority Data
Mar. 20, 2023 (DE) 10 2023 202 455.1

(51) Int. Cl. A01G 3/053; A01G 3/04

(52) U.S. Cl. CPC A01G 3/053; A01G 2003/0461

(57) ABSTRACT

A blade arrangement for a garden tool is disclosed. The blade arrangement has a guide rail, a first blade bar that can be moved relative to the guide rail, and a cover. The first blade bar is guided so as to be displaceable in an oscillating manner. The guide rail is located between the cover and the first blade bar. The first blade bar has slotted holes. The guide rail has through-openings. The cover has screw bosses. The first blade bar is attached to the cover with screws. The screws are guided through the slotted holes of the first blade bar and the through-openings of the guide rail and screwed into an internal thread of the screw bosses.

This application claims priority under 35 U.S.C. § 119 to patent application no. DE 10 2023 202 455.1, filed on Mar. 20, 2023 in Germany, the disclosure of which is incorporated herein by reference in its entirety.

The disclosure relates to a blade arrangement for a garden tool and a garden tool with such a blade arrangement.

### BACKGROUND

Blade arrangements, also known as blade bars, for hedge trimmers are known from the state of the art. DE 10 2005 014 576 B4, for example, discloses a blade bar of a hedge trimmer driven by a motor, comprising a supporting blade rail with a support bar, at least one shearing blade guided on the blade rail so as to be displaceable in an oscillating manner, with laterally projecting incisors clamping a blade plane, and a cutting guard mounted on the blade rail and extending at least over a partial area of the shearing blade. The cut guard has through-openings through which the blade rail and other elements can be attached. In particular, the shearing blades are attached to the support bar.

The attachment of the shearing blades to the blade arrangement, as known from the prior art, is technically complex. Many individual components have to be matched to each other and the through-openings in the cut guard can impair the appearance of the blade arrangement.

### SUMMARY

One task of the disclosure is to provide an improved blade arrangement. A further task of the disclosure is to provide a garden tool with such a blade arrangement. This problem is solved by the subject matter disclosed herein. Advantageous further embodiments are given below.

According to a first aspect, the disclosure relates to a blade arrangement for a garden tool, in particular for a hedge trimmer, in particular for a motor-driven hedge trimmer. The blade arrangement has a guide rail, a first blade bar that can be moved relative to the guide rail and a cover. The first blade bar is guided so as to be displaceable in an oscillating manner. This can be designed in such a way that the first blade bar is intended to perform a reciprocating movement. The guide rail is located between the cover and the first blade bar. The first blade bar has slotted holes. The guide rail has through-openings, which can be designed as through-holes or can have an internal thread. The cover has screw bosses. The first blade bar is attached to the cover with screws. The screws are guided through the slotted holes of the first blade bar and the through-openings of the guide rail and screwed into an internal thread of the screw bosses. The slotted holes of the first blade bar can be designed along an intended direction of movement of the first blade bar, so that an oscillating displacement of the first blade bar around the screws is possible. In particular, it may be provided that the screws are screwed into the screw bosses from below. The first blade bar can have laterally protruding incisors that clamp a blade plane.

By screwing the screws into the screw bosses of the cover, a simple design of the blade arrangement can be achieved. First, the guide rail can be inserted into the cover. The first blade bar is then placed on the guide rail and the screws are then screwed in. The screws inside the slotted holes of the first blade bar also determine possible movements of the first blade bar along the guide rail.

According to a second aspect, the disclosure relates to a garden tool, in particular a motor-driven hedge trimmer, comprising a blade arrangement according to the disclosure. Furthermore, it may be provided that the garden tool has a housing with a motor for driving the garden tool. In particular, the drive can drive the oscillating displaceable movement of the first blade bar, i.e., the reciprocal or reciprocating movement of the first blade bar.

In one embodiment of the blade arrangement, it also has a second blade bar. The first blade bar is movable relative to the second blade bar. The second blade bar can be fixed in relation to the guide rail or the cover. The second blade bar can also have laterally protruding incisors that span a blade plane.

In one embodiment of the blade arrangement, the second blade bar is movable relative to the guide rail. Slotted holes can also be provided in the second blade bar for this purpose, wherein the screws are also guided through the slotted holes in the second blade bar. In the garden tool, the drive can then also be used to move the second blade bar, so that both the first blade bar and the second blade bar are driven by the drive.

In one embodiment of the blade arrangement, spacer elements are arranged between the blade bars. The spacer elements can be designed as washers.

In one embodiment of the blade arrangement, at least one of the screws comprises a threaded portion, a spacer portion and a screw head. The threaded portion is located inside one of the through-openings of the guide rail and inside one of the screw bosses. The spacer portion is arranged inside one of the slotted holes of the first blade bar. If a movable second blade bar with slotted holes is provided, the spacer portion can also be arranged in the slotted holes of the second blade bar. In particular, the spacer portion can serve as a guide element for the first blade bar or the first blade bar and the second blade bar. In particular, several or all of the screws can be designed in this way. It can then be provided that the spacer portions of these screws are also arranged within slotted holes of the first blade bar or the first blade bar and the second blade bar and serve as a guide element for the first blade bar or the first blade bar and the second blade bar. The spacer portion or the spacer portions can, for example, have two parallel sides that are arranged parallel to the slotted holes.

In one embodiment of the blade arrangement, the spacer portion of the screw has a support. In particular, the support can be adjacent to the guide rail. This can make assembly easier.

In one embodiment of the blade arrangement, the spacer portion of the screw is cylindrical. A diameter of the spacer portion is smaller than a width of the slotted hole. In particular, the diameter of the spacer portion can be between 90 and 99 percent of the width of the slotted hole. These dimensions make it easy to guide the first blade bar or, if necessary, both blade bars.

In one embodiment of the blade arrangement, the cover has a closed upper side. In particular, the upper side can be continuous. In particular, the upper side can be free of holes for screws or through-holes.

In one embodiment of the blade arrangement, the through-openings of the guide rail are round and have an internal thread. The internal thread can be adapted to the thread of the screws.

In one embodiment of the blade arrangement, the screws have a self-tapping thread. In this embodiment, it is particularly possible that the internal threads of the screw bosses and, if necessary, the internal threads of the guide rail are cut by means of the self-tapping threads of the screws.

In one embodiment of the blade arrangement, the cover has a recess that is essentially guided along the guide rail. In particular, the recess can be a U-shaped recess. The guide rail can be inserted into the recess. In particular, the guide rail can be arranged completely within the recess or at least at one point in the cross-section completely within the recess.

In one embodiment of the blade arrangement, the guide rail has a U-profile. The first blade bar can then be attached to a connecting element of the guide rail.

In one embodiment of the blade arrangement, the guide rail rests against the cover with two free ends. The free ends can also be referred to as upper ends.

In one embodiment of the blade arrangement, the screw bosses have reinforcing structures. These can be cross-shaped. The reinforcing structures and in particular the cross-shaped reinforcing structures can be adjacent to the guide rail. In particular, the reinforcing structures, if present, can fill the U-profile of the guide rail. The cover can be centered relative to the guide rail by means of the reinforcing structures and in particular the cross-shaped reinforcing structures. The reinforcing structures, and in particular the cross-shaped reinforcing structures, can support the cover relative to the guide rail. Axially along the screw bosses, the reinforcing structures, and in particular the cross-shaped reinforcing structures, can prevent overloading of the screw bosses by allowing the reinforcing structures, and in particular the cross-shaped reinforcing structures, to potentially strike axially against the guide rail. Laterally, the reinforcing structures and in particular the cross-shaped reinforcing structures ensure centering within the guide rail, even if the outer surfaces of the cover spread. Furthermore, the reinforcing structures and in particular the cross-shaped reinforcing structures can be used to align or center the cover within the guide rail during assembly.

In one embodiment of the blade arrangement, the cover is made of plastic. In one embodiment of the blade arrangement, the guide rail is made of metal. In one embodiment of the blade arrangement, the cover has protrusions. The protrusions cover the incisors of the first blade bar and possibly also the second blade bar. The protrusions can be designed to overlap directly or with an overlap.

### BRIEF DESCRIPTION OF THE DRAWINGS

Exemplary embodiments of the disclosure are explained with reference to the subsequent drawings. In the schematic drawings, the following are shown:

FIG. 1 an isometric view of a garden tool with a blade arrangement;

FIG. 2 a top view of the garden tool in FIG. 1;

FIG. 3 a view from below of the garden tool in FIGS. 1 and 2;

FIG. 4 an exploded view of a blade arrangement that can be provided in the garden tool of FIGS. 1 through 3;

FIG. 5 a cross-section through the blade arrangement of FIG. 4;

FIG. 6 a cross-section of a cover, a guide rail and a screw of a blade arrangement; and

FIG. 7 a detailed view of a cover of a blade arrangement.

### DETAILED DESCRIPTION

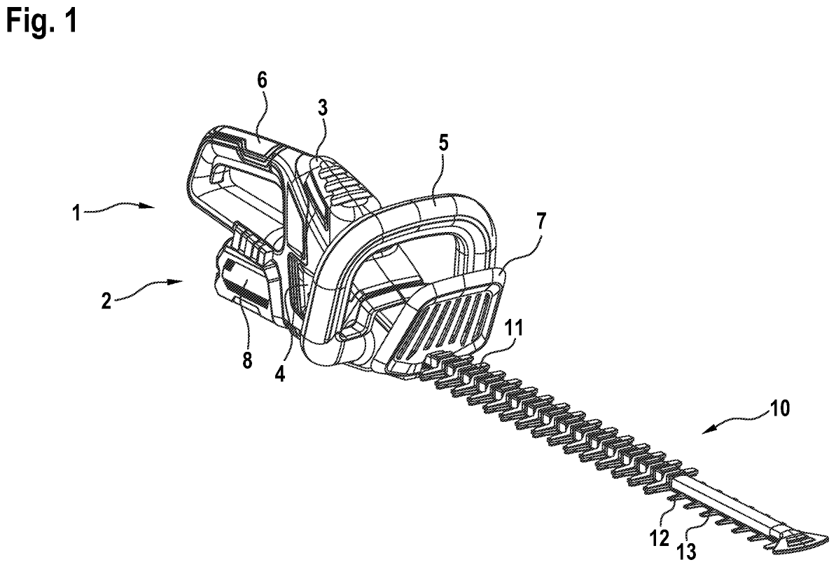

FIG. 1 shows a garden tool 1, in particular a motor-driven hedge trimmer, comprising a blade arrangement 10 and a housing 3 with a motor for driving the garden tool 1. The garden tool 1 also optionally has a first handle 5 and a second handle 6 for holding the garden tool 1, a protective plate 7 and a power supply 8 for the motor 4. The power supply 8 is shown here as an accumulator, wherein the motor 4 is then an electric motor. As an alternative to the rechargeable battery, the power supply 8 can take the form of a power cable. Furthermore, the engine 4 can be an internal combustion engine and the energy supply 8 can then take the form of a fuel tank.

The blade arrangement 10 has a cover 11, a first blade bar 12 and optionally a second blade bar 13. Further elements of the blade arrangement 10 are explained in more detail below. The motor 4 is used in particular to drive the movement of the first blade bar 12 or both blade bars 12, 13.

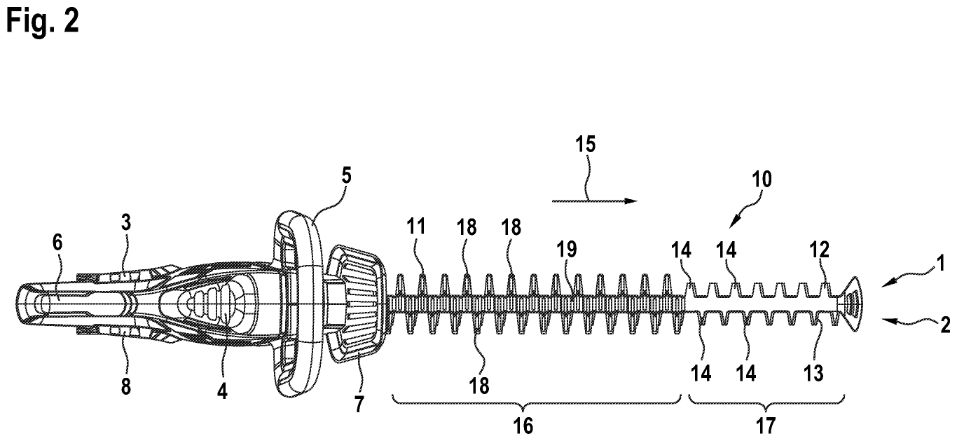

FIG. 2 shows a top view of the garden tool 1 or hedge trimmer 2 of FIG. 1. The first blade bar 12 has laterally protruding incisors 14 that clamp a blade plane. The blade plane lies in the drawing plane of FIG. 2. The second blade bar 13 can also have corresponding laterally protruding incisors 14 that clamp a blade plane. The first blade bar 12 is guided so as to be displaceable in an oscillating manner, with the displacement of the first blade bar in an oscillating manner taking place along a main direction of extension 15 of the blade arrangement 10.

The cover 11 has a first area 16 and a second area 17. In one exemplary embodiment of the blade arrangement 10, the cover 11 is made of plastic. In one exemplary embodiment of the blade arrangement 10, the cover 11 has protrusions 18. In FIGS. 1 and 2, the protrusions 18 are arranged in particular in the first portion 16 of the cover 11, wherein no protrusions 18 are provided in the second portion 17. However, it is also possible that the cover 11 has no protrusions 18 or has protrusions 18 over its entire length, i.e., also in the second area 17. The protrusions 18 cover the incisors 14 of the first blade bar 12 and possibly also of the second blade bar 13. The protrusions can be designed to overlap directly or with an overlap. For the sake of clarity, not all incisors 14 or protrusions 18 are marked with a reference sign here or in other figures.

In one exemplary embodiment of the blade arrangement 10, the cover 11 has a closed upper side 19. The upper side 19 can in particular be continuous. In particular, the upper side 19 can be free of holes for screws or through-holes. Such an upper side 19 is shown in FIG. 2.

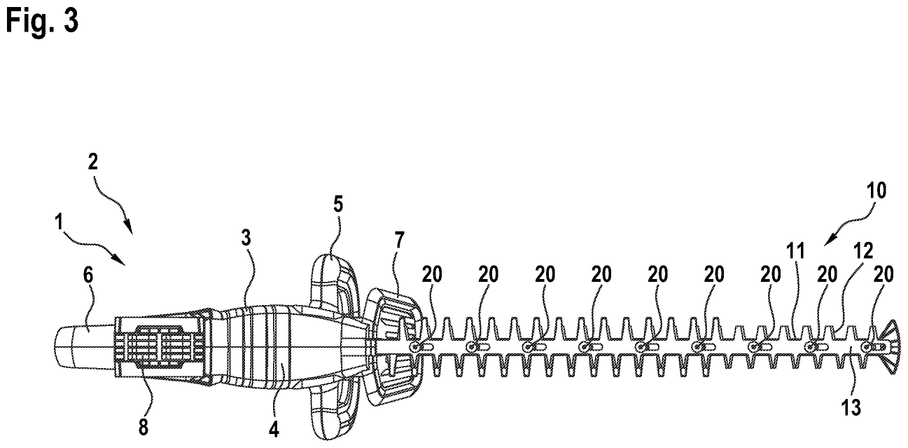

FIG. 3 shows a top view from below of the garden tool 1 or hedge trimmer 2 of FIGS. 1 and 2. It can be seen that the first blade bar 12 and the second blade bar 13 are attached to the cover 11 by means of screws 20. For the sake of clarity, not all screws 20 are marked with a reference symbol here or in other figures.

In the following, the blade arrangement 10 is described in more detail and a blade arrangement according to the disclosure is described in more detail. All the exemplary embodiments already described can be used in the blade arrangements described below. The blade arrangements described below can be used in the garden tools 1 or hedge trimmers 2 of FIGS. 1 through 3.

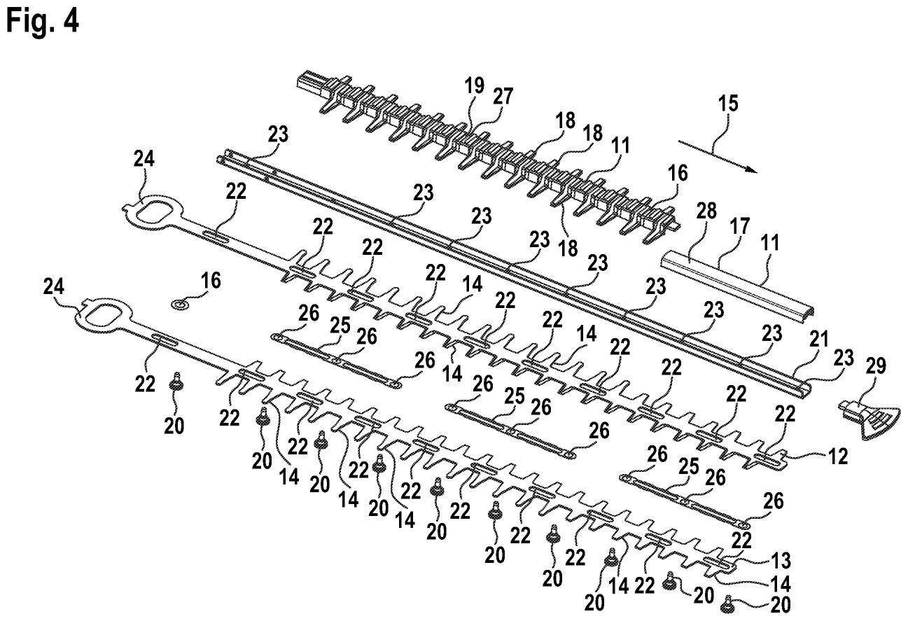

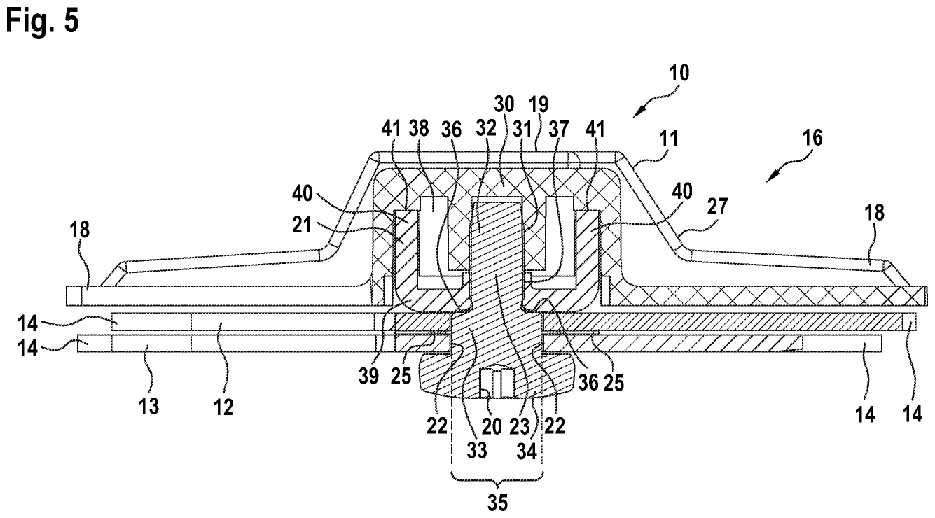

FIG. 4 shows an exploded view of a blade arrangement 10 for a garden tool 1, in particular for a hedge trimmer 2, in particular for a motor-driven hedge trimmer 2. The blade arrangement 10 has a guide rail 21, the first blade bar 12 already described and movable relative to the guide rail 21, and the cover 11 already described. The first blade bar 12 is guided so as to be displaceable in an oscillating manner. This can be designed in such a way that the first blade bar 12 is intended to perform a reciprocating movement, in particular along the main direction of extension 15 of the blade arrangement 10. The guide rail 21 is arranged between the cover 11 and the first blade bar 12. The first blade bar 12 has slotted holes 22. The guide rail 21 has through-openings 23, which can be designed as through-holes or bores or which can have an internal thread. The cover 11 also has screw bosses that are not visible here, which are explained in connection with FIG. 5. The first blade bar 12 is attached to the cover 11 by means of the screws 20. The screws 20 are guided through the slotted holes 22 of the first blade bar 12 and the through-openings 23 of the guide rail 21 and screwed to an internal thread of the screw bosses. As shown in FIG. 4, the slotted holes 22 of the first blade bar 11 can be designed along an intended direction of movement of the first blade bar 12, i.e., in particular parallel to the main direction of extension 15, so that an oscillating displacement of the first blade bar 12 about the screws 20 is possible. In particular, it may be provided that the screws 20 are screwed into the screw bosses from below. The first blade bar again has the already described, laterally protruding incisors 14 that clamp the blade plane.

By screwing the screws 20 into the screw bosses of the cover 11, a simple structure of the blade arrangement 10 can be achieved. First, the guide rail 21 can be inserted into the cover 11. The first blade bar 12 is then placed on the guide rail 21 and the screws 20 are then screwed in. The screws 20 within the slotted holes 22 of the first blade bar 12 also specify possible movements of the first blade bar 12 along the guide rail 21.

The drive explained in connection with FIG. 1 can in particular drive the oscillating displaceable movement of the first blade bar 12, i.e., the reciprocal or reciprocating movement of the first blade bar 12. For this purpose, the first blade bar, as shown in FIG. 4, can have a drive element 24 with which a movement of the motor 4 can be transmitted to the first blade bar 12, possibly by means of an eccentric.

FIG. 4 shows further optional features, which are referred to below as exemplary embodiments.

In an exemplary embodiment of the blade arrangement 10, it also has the second blade bar 13. The first blade bar 12 is movable relative to the second blade bar 13. The second blade bar 13 can be fixed in relation to the guide rail 21 or the cover 11. The second blade bar 13 can also have laterally protruding incisors 14 that clamp a blade plane. Also for the second blade bar 13, not all incisors 14 are provided with a reference sign in order to increase clarity.

In one exemplary embodiment of the blade arrangement 10, the second blade bar 13 is movable relative to the guide rail 21. Slotted holes 22 can also be provided in the second blade bar 13 for this purpose. The screws 20 are also guided through the slotted holes 22 of the second blade bar 13. In the garden tool 1, the drive can then also be used to move the second blade bar 13, so that both the first blade bar 12 and the second blade bar 13 are driven by the drive. For this purpose, the second blade bar 13 also has a drive element 24, with which a movement of the motor 4 can be transmitted to the second blade bar 13, possibly by means of an eccentric.

In one exemplary embodiment of the blade arrangement 10, spacer elements 25 are arranged between the blade bars 12, 13. The spacer elements 25 can be designed as washers. The spacer elements 25 can have through-holes 26, wherein the screws 20 can be guided through the through-holes 26. In particular, differently designed spacer elements 25 are shown in FIG. 4. In particular, spacer elements 25 can be provided with more than one through-hole 26, for example with three through-holes 26. In one exemplary embodiment of the blade arrangement 10, the guide rail 21 is made of metal.

In one exemplary embodiment of the blade arrangement 10, the cover 11 has a closed upper side 19. The upper side 19 can in particular be continuous. In particular, the upper side 19 can be free of holes for screws or through-holes.

In one exemplary embodiment of the blade arrangement 10, the cover 11 is made of plastic. In one exemplary embodiment of the blade arrangement 10, the cover 11 has protrusions 18. In particular, the cover 11 has a first cover element 27 in the first area 16 and a second cover element 28 in the second area 17. The protrusions 18 are only arranged on the first cover element 27, but not on the second cover element 28. However, only one of the two cover elements 27, 28 can also be provided. The protrusions 18 cover the incisors 14 of the first blade bar 12 and possibly also of the second blade bar 13. The protrusions 18 can be designed to overlap directly or with an overlap. The cover 11 also has a tip 29, which is arranged on the side of the blade arrangement 10 facing away from the housing 3 or the drive elements 24. The first cover element 27, the second cover element 28 and the tip 29 can be connected by means of a clip connection.

FIG. 5 shows a cross-section through the blade arrangement 10 of FIG. 4, the cross-section passing through the first area 16 and thus through the first cover element 27 with the protrusions 18. The cover 11 has a screw boss 30 with an internal thread 31. The screw 20 is screwed to the internal thread 31 of the screw boss 30. The screw boss 30 is designed in one piece with the cover 11. Further screw bosses 30 are provided in the drawing plane behind and in front of the illustration in FIG. 5. The cover 11 with the screw bosses 30 can be designed as an injection-molded part, in particular as an injection-molded or compression-molded part made of plastic. Similar to the screw boss 30 shown in FIG. 5, such screw bosses can also be provided in the second cover element 28.

FIG. 5 shows further optional features, which are referred to below as exemplary embodiments.

In one exemplary embodiment of the blade arrangement 10, at least one of the screws 20, as shown in FIG. 5, comprises a threaded portion 32, a spacer portion 33 and a screw head 34. The threaded portion 32 is arranged within one of the through-openings 23 of the guide rail 21 and within the screw boss 30. The threaded portion 32 can be adapted to the internal thread 31 of the screw boss 30. The spacer portion 33 is arranged within one of the slotted holes 22 of the first blade bar 12. If the movable second blade bar 13 is provided with slotted holes 22, the spacer portion 33 can also be arranged in the slotted holes 22 of the second blade bar 13, as shown in FIG. 5. In particular, the spacer portion 33 can serve as a guide element for the first blade bar 12 or the first blade bar 12 and the second blade bar 13. In particular, several or all of the screws 20 can be designed in this way. It may then be provided that the spacer portions 33 of these screws 20 are also arranged within slotted holes 22 of the first blade bar 12 or the first blade bar 12 and the second blade bar 13 and serve as a guide element for the first blade bar 12 or the first blade bar 12 and the second blade bar 13. The spacer portion 33 or the spacer portions 33 may, for example, have two parallel sides that are arranged parallel to the slotted holes 22.

In one exemplary embodiment of the blade arrangement 10, the spacer portion 33 of the screw 20 is cylindrical. In particular, the spacer portions 33 of all screws 20 can be cylindrical. A diameter of the spacer portion 33 is smaller than a width 35 of the slotted hole 22. In particular, the diameter of the spacer portion 33 can be between 90 and 99 percent of the width 35 of the slotted hole 22. With these dimensions, simple guidance of the first blade bar 12 or, if necessary, both blade bars 12, 13 can be achieved.

In one exemplary embodiment of the blade arrangement 10, the spacer portion 33 of the screw 20 has a support 36. In particular, the support 36 can be adjacent to the guide rail 21. This can make assembly easier.

In one exemplary embodiment of the blade arrangement 10, the through-openings 23 of the guide rail 21 are round and have an internal thread 37. The internal thread 37 can be adapted to the thread of the screws 20 in the threaded portion 32.

In one exemplary embodiment of the blade arrangement 10, the screws 20 have a self-tapping thread. In this embodiment, it is possible in particular that the internal threads 31 of the screw bosses 30 and, if necessary, also the internal threads 37 of the guide rail 21 are cut by means of the self-tapping threads of the screws 20.

In one exemplary embodiment of the blade arrangement 10, the cover 11 has a recess 38 guided essentially along the guide rail 21. In particular, the recess 38 can be a U-shaped recess 38. The guide rail 21 can be inserted into the recess 38. In particular, the guide rail 21 can be arranged completely within the recess 38 or at least at one point in the cross-section completely within the recess 38. Such an arrangement is shown in FIG. 5.

In one exemplary embodiment of the blade arrangement 10, the guide rail 21 has a U-profile, as shown in FIG. 5. The first blade bar 12 can then be attached to a connecting element 39 of the guide rail 21.

In one exemplary embodiment of the blade arrangement 10, the guide rail 21 rests against the cover 11 with two free ends 40. The free ends 40 can also be referred to as upper ends. The free ends 40 can in particular adjoin supports 41 of the cover, the supports 41 being arranged within the recess 38 of the cover 11.

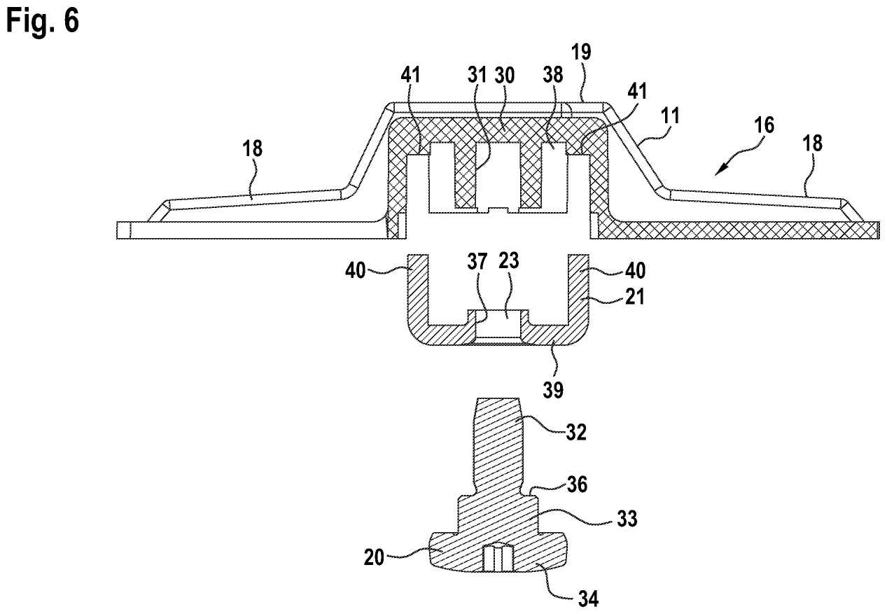

FIG. 6 shows the cover 11, the guide rail 21 and the screw 20 of FIG. 5 before assembly of the blade arrangement 10. The guide rail 21 with U-profile can be inserted into the recess 38 of the cover, wherein the dimensions of the recess 38 and the guide rail 21 can be matched to each other. The screw 20 can then fix the guide rail 21 in the recess 38 with the support 36.

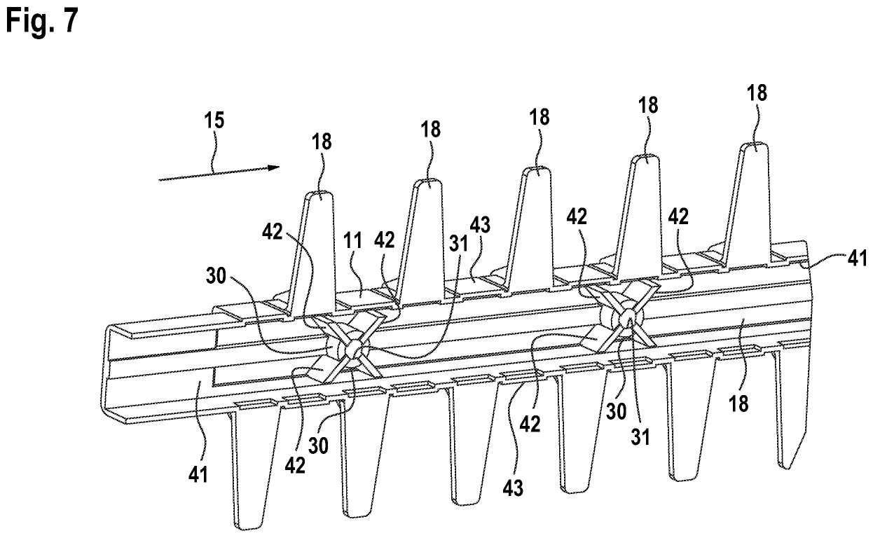

FIG. 7 shows an isometric view of the cover 11, which can be designed as already described. In particular, the recess 38 with the support 41 and two screw bosses 30 with internal thread 31 explained in connection with FIG. 5 are visible. Optionally, the screw bosses 30 have reinforcing structures 42. These can be cross-shaped, as shown in FIG. 7. The reinforcing structures 42 and in particular the cross-shaped reinforcing structures 42 can be adjacent to the guide rail 21. In particular, the reinforcing structures 42, if present, can fill the U-profile of the guide rail 21. This is indicated in FIG. 7 by the fact that the reinforcing structures 42 are guided up to the support 41. The upper ends of the guide rail 21 are then arranged in the area of the support 41, as shown in FIG. 5. By means of the reinforcing structures 42 and in particular the cross-shaped reinforcing structures 42, the cover 11 can be centered relative to the guide rail 21. The reinforcing structures 42, and in particular the cross-shaped reinforcing structures 42, can support the cover 11 relative to the guide rail 21. Axially along the screw bosses 30, the reinforcing structures 42 and in particular the cross-shaped reinforcing structures 42 can prevent the screw bosses 30 from being overloaded by the reinforcing structures 42 and in particular the cross-shaped reinforcing structures 42 potentially striking axially against the guide rail 21. Laterally, the reinforcing structures 42 and in particular the cross-shaped reinforcing structures 42 ensure centering within the guide rail 21, even if the outer surfaces 43 of the cover 11 spread. Furthermore, the reinforcing structures 42 and in particular the cross-shaped reinforcing structures 42 can serve to align or center the cover 11 within the guide rail 21 during assembly.

Although the disclosure has been described in more detail using preferred exemplary embodiments, the disclosure is not limited by the disclosed examples, and other variations can be derived from this by a person skilled in the art without departing from the scope of protection of the disclosure.

What is claimed is:

1. A blade arrangement for a garden tool, comprising:
a guide rail;
a first blade bar configured to be movable relative to the guide rail; and
a cover,
wherein the first blade bar is configured to be guided so as to be displaceable in an oscillating manner,
wherein the guide rail is arranged between the cover and the first blade bar,
wherein the first blade bar has slotted holes,
wherein the guide rail has through-openings,
wherein the cover has screw bosses,
wherein the first blade bar is fastened to the cover by way of screws, and
wherein the screws are guided through the slotted holes of the first blade bar and the through-openings of the guide rail and are screwed to an internal thread of the screw bosses.

2. The blade arrangement according to claim 1, further comprising a second blade bar, wherein the first blade bar is configured to be movable relative to the second blade bar.

3. The blade arrangement according to claim 2, wherein the second blade bar is configured to be movable relative to the guide rail.

4. The blade arrangement according to claim 2, further comprising spacer elements arranged between the first blade bar and the second blade bar.

5. The blade arrangement according to claim 1, wherein:
at least one of the screws comprises a threaded portion, a spacer portion, and a screw head,
the threaded portion is arranged within one of the through-openings of the guide rail and within one of the screw bosses, and
the spacer portion is arranged within one of the slotted holes of the first blade bar.

6. The blade arrangement according to claim 5, wherein the spacer portion of the screw has a support which adjoins the guide rail.

7. The blade arrangement according to claim 5, wherein:
the spacer portion of the screw is cylindrical,
a diameter of the spacer portion is smaller than a width of the slotted hole, and
the diameter of the spacer portion is between 90 and 99 percent of the width of the slotted hole.

8. The blade arrangement according to claim 1, wherein the cover has a closed upper side.

9. The blade arrangement according to claim 1, wherein the through-openings of the guide rail are round and have an internal thread.

10. The blade arrangement according to claim 1, wherein the screws have a self-tapping thread.

11. The blade arrangement according to claim 1, wherein:
the cover has a recess guided essentially along the guide rail, and
the guide rail is configured to be inserted into the recess.

12. The blade arrangement according claim 1, wherein the guide rail comprises a U-profile.

13. The blade arrangement according to claim 12, wherein the guide rail bears with two free ends against the cover.

14. The blade arrangement according to claim 1, wherein the screw bosses comprise reinforcing structures.

15. A motor-driven hedge trimmer, comprising:
a blade arrangement according to claim 1;
a housing; and
a motor configured to drive the motor-driven hedge trimmer.

16. The blade arrangement according to claim 1, wherein the garden tool is a motor-driven hedge trimmer.

17. The blade arrangement according to claim 11, wherein the recess is a U-profile-shaped recess.
